(19) United States
(12) Patent Application Publication
(10) Pub. No.: US 2022/0268307 A1
(43) Pub. Date: Aug. 25, 2022

(54) ONE WAY FASTENER

(71) Applicant: Oren BRODER, Rishon LeZion (IL)

(72) Inventor: Oren BRODER, Rishon LeZion (IL)

(21) Appl. No.: 17/676,578

(22) Filed: Feb. 21, 2022

Related U.S. Application Data
(60) Provisional application No. 63/151,731, filed on Feb. 21, 2021.

(51) Int. Cl. F16B 33/02

(52) U.S. Cl. CPC F16B 33/02

(57) ABSTRACT

The present invention relates to innovative fasteners for joining two or more objects together.

### CROSS REFERENCE TO RELATED APPLICATIONS

This application claims the benefit of priority to U.S. 63/151,731 filed on Feb. 21, 2021. The contents of this application are incorporated by reference in its entirety.

### FIELD OF THE INVENTION

The present invention relates in general to fasteners, specifically to disposable unidirectional fasteners designed to hold together two or more artifacts at hard-to-reach locations and/or where it is not possible to use a loop-fastener.

### BACKGROUND OF THE INVENTION

Various prior art fasteners are known, but many suffer from various disadvantages in that they are task-specific, comprise a multiplicity of parts which makes them complicated to use and/or their construction complicates their manufacture and increases their cost.

U.S. Pat. No. 2,181,966 describes a fastener that is connected to a part for fastening and having portions that expand or spring outwardly after their insertion through an aperture formed in a supporting member; U.S. Pat. No. 3,665,800 describes a snap-in type composite fastener for telescopic association; U.S. Pat. No. 4,973,212 describes a snap-in type fastener for securing an object to an apertured support that includes a shank member having predetermined diameter and length; and U.S. Pat. No. 4,043,245 describes a toggle plate that once inserted into the blind side of a wall opening, a sliding sleeve opens to enable tightening.

While the various prior art fasteners have provided improvements in the areas intended, there still exists a need for a snap-in fastener adapted to accommodate workpieces of different thicknesses at hard-to-reach areas in a simple manner.

Accordingly, the present invention provides such a fastener. The fastener of the invention is designed to be unidirectional and as such disposable. The term “unidirectional” as used herein refers to the fact that the closing movement of the fastener can be carried out in only one direction, and once closed the fastener cannot be opened.

### SUMMARY OF INVENTION

In a first aspect, the present invention provides a fastener 100 for joining two or more objects together, comprising: (a) a main body 102 comprising a serrated shank (shaft) with a proximal handle 103 and a deformable distal tip 101; and (b) a sleeve 110 designed to be pushed along said serrated shank from its handle 103 towards its tip 101, wherein: (i) said tip 101 is designed to be cramped when inserted through a pre-drilled hole and return to its original shape once it exits the hole on its other side, such that once the tip 101 exits the hole, it returns to its original shape and cannot be pulled back through the drilled hole, and (ii) said sleeve 110 comprises a counter shank 111 designed to interact with the serrated shank on the main body 102 to thereby prevent pulling said sleeve 110 backwards along said main body 102.

In a second aspect, the preset invention provides a method for joining two or more objects together without having access to one of the sides of said objects, comprising the steps of: (a) passing a fastener 100 of the invention through a hole within each of said two or more objects until the fastener's tip 101 passes through all the objects and exits the hole; and (b) pushing the sleeve 110 along the main body 102 towards the tip 101, thereby fastening said two or more objects together.

### BRIEF DESCRIPTION OF DRAWINGS

FIGS. 1A-1D illustrate one possible configuration of a fastener of the invention.

FIGS. 2A-2C illustration enlargements of the fastener's components: the main body (FIG. 2A); the tip (FIG. 2B); and the sleeve (FIG. 2C).

FIGS. 3A-3F illustrate how the fastener of FIG. 1 is used to connect two objects together.

FIGS. 4A-4F illustrate how the fastener of FIG. 1 is used to connect two ends of a (metal) band.

### DETAILED DESCRIPTION OF THE INVENTION

The present invention is based on the finding that it is hard or impossible to connect one object to another at hard-to-reach locations, where it is hard if not impossible to reach both sides of the objects to be connected, such as when connecting a cover/roofing to an existing construct.

This invention thus relates to fasteners/anchoring devices, and more particularly to a fastener 100 particularly suited for use with wall/artifact that is accessible from only one surface thereof, serving to provide simple and easy to use means for anchoring an object to said wall/artifact.

A variety of situations exist in which it is desired to secure an object to a wall, which does not normally have access to the other side of the object and/or the wall to facilitate their attachment. Thus, when attempting to secure, e.g., a flexible cover or a plaster board, sheet rock, fiberglass, etc., to a pergola's upper frame, either two users work together (which is not always an option) or a single user is required to stand on top of the pergola to fasten such cover to the frame, which is unsafe and uncomfortable.

Accordingly, the present invention provides a fastener/anchoring device 100 designed to connect two or more artifacts/objects together in a fast and simple manner, by enabling fastening them together from only one side thereof, i.e. without requiring access to the other side of the artifacts/objects, as currently required by many known fasteners.

The fastener 100 of the invention can be fabricated from any suitable material, such as plastic, polycarbonate, metals, alloys, etc., or any combination thereof according to use and desire. For instance, the fastener's main body can be made of rigid material such as metal or plastic, whereas the fastener's tip, which is deformable, can be made from thinner plastic or rigid rubber that provides elasticity and strength.

The fastener 100 of the invention is further characterized by having various sizes, length and width, all according to need and intended use. For instance, for anchoring thin sheet of material to a frame (as a pergola), shorter and thinner fasteners can be used. And when two heavy objects are to be connected or such that require withstanding stronger pulling forces, a thicker fastener can be used, which is optionally also made of more resilient material (e.g. metal instead of plastic). The length of the fastener 100 can also be modified, i.e. fabricated to be longer to enable connecting two thick objects together, or shorter. In addition, the fastener 100 can be cut after securing the objects together, thereby removing redundant and protruding residues of the fastener's main body.

The size of the fastener 100 of the invention can vary according to need, and can be about 15 cm long, e.g. less than 14, 13, 12, 11, 10, 9, 8, 7, 6, 5, 4, 3, 2, 1 cm or less, or can be longer than 15 cm. The length of the fastener 100 can be determined, e.g. according to the width of the artifacts to be connected/fastened together.

In certain embodiments, the fastener 100 of the invention can be fabricated to be task specific, i.e. be part of an artifact that is designed to be secured to another. For instance, a board (e.g. car door or a frame/box of an electric device) can be provided with fasteners of the invention to enable securing thereto another element (e.g. an interior to the car door, or a closure to the frame/box of the electric device). This further provide a securing means that could identify if a user removed the other element (e.g. removed the car door interior or opened the frame/box of the electric device). Accordingly, in specific embodiments, the fastener 100 of the invention is implemented within an artifact/object/surface during manufacture.

The fastener 100 of the invention is suitable for use in any field, such as industry, automobile, factories, electricity, pluming, roofing, etc.

Accordingly, in a first aspect, the present invention provides a fastener 100 for joining two or more objects/artifacts together, the fastener comprising of two main components: (a) a main body 102 having a serrated shank (shaft) with a proximal handle 103 and a deformable distal tip 101; and (b) a sleeve 110 designed to be pushed along said serrated shank from its handle 103 towards its tip 101 (similar to a zip tie), wherein: (i) said tip 101 is designed to be cramped when inserted through a pre-drilled hole and return to its original shape once it exits the hole on its other side, such that once the tip 101 exits the hole, it returns to its original shape and cannot be pulled back through the drilled hole, and (ii) said sleeve 110 comprises a counter shank 111 designed to interact with the serrated shank on the main body 102 to thereby prevent pulling said sleeve 110 backwards along said main body 102.

In specific embodiments of the fastener 100, the handle 103 is absent.

One advantage of the fastener 100 of the invention is that it does not require any tools for using it: all a user needs to do is push the sleeve 110 over the main body 102, and the two or more objects are fastened together. In specific embodiments, the user is required to first drill a hole(s) in the two or more objects, but that is not part of the operation of the fastener 100 itself. This differentiates the present invention from other similar fasteners (such as rivets, studs, and dead bolts), which require a special tool(s) for using thereof (such as nail gun, hand riveter or a screwdriver).

The structure of the fastener 100 is such that it allows insertion through a hole within the artifacts to be connected/fastened together, while preventing its extraction backwards, i.e. after the tip 101 has exited the hole on the other side. This, together with the sleeve 110 that is moved towards the tip 101, enable to tighten and secure the attachment/fastening of the two or more artifacts together.

In certain embodiments, the fastener 100 of the invention does not include hinges or other moving parts except for the sleeve 110 that moves along the main body 102 and the tip 101 that is deformable, but returns to its original shape once it is out of the hole through which it was passed/pushed.

In certain embodiments of the fastener 100 of the invention, the tip 101 is conic or dome-shaped having a diameter larger than that of the main body 102—i.e. the diameter at the wider base of the cone/dome is larger than the external diameter of the fastener's main body 102. Due to the special structure and/or material from which the tip 101 is made, when it is pushed through a hole with a diameter that is smaller than that of the tip 101, the tip 101 collapses to enable passage of the fastener 100 through the hole and returns to its original shape and diameter once it exits the hole (on the other side). Once out of the hole, the tip 101 cannot be collapsed again or folded t the other direction, thereby preventing extraction of the fastener from the hole (by puling is backwards).

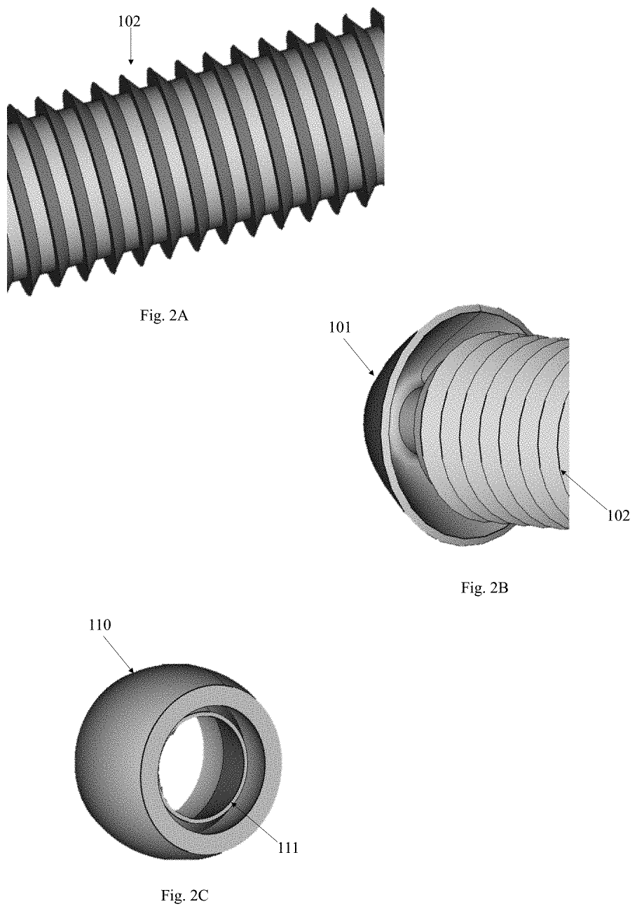

The main body 102 is serrated, meaning that it has a plurality of small protrusions/ratchet teeth across. These protrusions/ratchet teeth, together with the counter protrusion(s) or ratchet tooth(s) 111 within the sleeve 110 enable the sleeve 110 to move only in one direction and prevent counter movement. The number of serrations/protrusions/ratchet teeth and the distance between two adjacent serrates/protrusions, as well as the angle of such serrates/protrusions/ratchet teeth can vary according to the type of fastener and intended use. The serrates/protrusions can be constructed to be all around the main body, i.e. a complete circle (see illustration in FIG. 2A), or can be partially surrounding, i.e. two, three, four, five, or more arches separated with a non-serrated surface.

The fastener's main body 102 can be of any shape, size, diameter and length, and can be made from any suitable material. In specific embodiments, the main body 102 is cylinder shaped.

In certain embodiments, the proximal handle 103 is a deformable handle that can be cramped to allow passage of the sleeve 110 thereover. In certain embodiments, the handle 103 is designed to be pulled or held by the user while pushing the sleeve 110 over the main body 102 to facilitate tighter fastening of the two or more objects together by the fastener 100.

The sleeve 110 acts as the locking mechanism of the fastener of any of the embodiments above. The sleeve 110 is constructed as a cylinder with an inner diameter that fits the outer diameter of the main body 102 while allowing movement of the sleeve 110 over the main body 102. The movement of the sleeve 110 over the main body 102 is unidirectional, i.e. limited to one direction, due to the interaction between the ratchet teeth/protrusions/serrated shank on the main body 102 and the inner counter shank/ratchet tooth(s) 111 on the inner surface of the sleeve 110. In certain embodiments, the inner counter shank 111 on the inner surface of the sleeve 110 is constructed as a round tongue/construct/protrusion around the entire inner diameter of the sleeve 110. In specific embodiments, the inner counter shank 111 comprises 1, 2, 3, 4, 5, 6, 7, 8, or more rounded constructs. In certain embodiments, the inner counter shank 111 has an angle that is opposite to that of the protrusions/ratchet teeth on the main body 102, thereby enabling stronger holding force that prevents withdrawal of the sleeve 110. In certain embodiments, the inner diameter of the inner counter shank 111 is smaller than the diameter of the edge of the protrusions/ratchet teeth on the main body 102, whereas said inner counter shank 111 is designed to be pushed inwardly as it is pushed along the main body 102 and against its protrusions/ratchet teeth, and spring back to its original shape after passing each protrusion/ratchet tooth, to thereby prevent withdrawal of the sleeve 110.

In certain embodiments, the inner counter shank(s) 111 is rigid and the protrusions/ratchet teeth on the main body 102 are the ones that pushed in/cramped when the sleeve 110 is pushed along the main body 102, and spring back to their original shape after each inner counter shank 111 of the sleeve passes, to thereby prevent withdrawal of the sleeve 110.

The terms “protrusions”, “serrates”, “shank” and “ratchet teeth” as used herein interchangeable refer to any construct that can be used to engage a counter construct and prevent counter pulling thereof, like a zip tie. For instance, the protrusions may have a hook-like shape and the counter construct may be a tab, or an opposite hook-shape. Another construct is groves along the surface (of the main body and/or the inner surface of the sleeve) that generate a protrusion-like structure.

The sleeve 110 can be of any shape, size, diameter and width, as long that its inner diameter fits the outer diameter of the main body 102. The sleeve 110 can be made from any suitable material.

In certain embodiments, the proximal handle 103 is a deformable handle that can be cramped to allow passage of the sleeve 110 thereover. In certain embodiments, the handle 103 is designed to be pulled or held by the user while pushing the sleeve 110 over the main body 102 to facilitate tighter fastening of the two or more objects together by the fastener 100.

In certain embodiments, the fastener 100 of any of the embodiments above is provided with the sleeve 110 mounted onto the main body 102. In such a configuration, the main body 102 may have a barrier at its proximal end before said handle 103, to prevent removal of the sleeve 110 from the main body 102. In specific embodiments, the barrier enables passage of the sleeve 110 for its sliding onto the main body 102 while preventing its extraction, i.e., one-directional barrier. In alternative specific embodiments, the fastener 100 is manufactured with the sleeve 110 on the main body 102.

In specific embodiments, the present invention provides a fastener 100 having an essentially one-piece structure which includes a main body 102, a deformable tip 101 at the body's distal end, and a sleeve 110 movable along the main body 102 from its proximal end to its distal end (i.e. towards the tip 101). In specific embodiments, the fastener 100 further includes a handle 103 at its proximal end.

In certain embodiments, the present invention provides a novel and practical snap-in fastener 100 according to any of the embodiments above, wherein workpieces of different thicknesses may be joined/accommodated by the simple movement of the sleeve 110 along the fastener's main body 102.

In certain embodiments, the present invention provides a fastener 100 for joining two or more objects together, comprising: (a) a cylinder-shaped main body 102 comprising a serrated shank with a deformable proximal handle 103 and a deformable distal tip 101; and (b) a sleeve 110 designed to be pushed along said serrated shank from its handle 103 towards its tip 101 (similar to a zip tie), wherein: (i) said tip 101 is designed to be cramped when inserted through a pre-drilled hole and return to its original shape once it exits the hole on its other side, such that once the tip 101 exits the hole, it returns to its original shape and cannot be pulled back through the drilled hole, (ii) said sleeve 110 comprises a counter shank 111 designed to interact with the serrated shank on the main body 102 to thereby prevent pulling said sleeve 110 backwards along said main body 102, and (iii) said proximal handle 103 can be cramped to allow passage of the sleeve 110 thereover.

In certain embodiments, the present invention provides a fastener 100 for joining two or more objects together, comprising: (a) a cylinder-shaped main body 102 comprising a serrated shank with a deformable distal tip 101; and (b) a sleeve 110 designed to be pushed along said serrated shank from its proximal end towards its tip 101 at its distal end, wherein: (i) said tip 101 is designed to be cramped when inserted through a pre-drilled hole and return to its original shape once it exits the hole on its other side, such that once the tip 101 exits the hole, it returns to its original shape and cannot be pulled back through the drilled hole, and (ii) said sleeve 110 comprises an inner counter shank 111 designed to interact with the serrated shank on the main body 102 to thereby prevent pulling said sleeve 110 backwards along said main body 102.

The fastener 100 according to any one of the embodiments above can be used to connect/fasten any two or more objects/artifacts, which are of the same type, in terms of size, material, shape and/or thickness. Alternatively, it can be used to connect/fasten any two or more different objects/artifacts, in terms of size, material, shape and/or thickness.

In certain embodiments, the fastener 100 of any of the embodiments above provides means to secure an object to, e.g., a wall or other structure, that has a blind opening therein from an accessible surface thereof.

In certain embodiments, the fastener 100 of any of the embodiments above is a disposable fastener.

In a second aspect, the present invention provides method for securing/joining two or more objects/artifacts together when there is limited or no access to one of the sides of these objects. In certain embodiments, the method comprises the steps of: (a) passing a fastener 100 according to any one of claims 1-10 through a hole within each of said two or more objects until the fastener's tip 101 passes through all the objects and exits the hole; and (b) pushing the sleeve 110 along the main body 102 towards the tip 101, thereby fastening said two or more objects together.

In certain embodiments, the method further comprises the one or both of the following preliminary steps: (i) drilling a hole through said two or more objects (the hole should be in a diameter suitable for passage of the fastener's main body 102); and (ii) aligning the holes of said two or more objects. Notably, when the drilling is carried out into all the objects to be fastened simultaneously, no alignment may be needed, since the generated hole is already aligned.

In certain embodiments, the present invention provides a method for joining two or more objects together without having access to one of the sides of said objects, comprising the steps of: (a) drilling a hole through said two or more objects (the hole should be in a diameter suitable for passage of the fastener's main body 102); (b) passing a fastener 100 according to any one of claims 1-10 through said hole within all the objects until the fastener's tip 101 passes through all the objects and exits the hole; and (c) pushing the sleeve 110 along the main body 102 towards the tip 101, thereby fastening said two or more objects together.

In certain embodiment, the method according to any of the embodiments above further comprises a step of removing (e.g. by cutting) a redundant/excess part of the fastener's main body that protrudes outwardly after fastening the sleeve 110, thereby leaving behind only the part of main body that is inside the connected objects and within the sleeve.

In certain embodiment of the method according to any of the embodiments above, the two or more objects are the same or of the same type, in terms of size, material, shape and/or thickness. Alternatively, they are different, in terms of size, material, shape and/or thickness.

In certain embodiments, the fastener 100 of any of the embodiments above provides means to secure an object to, e.g., a wall or other structure, that has a blind opening therein from an accessible surface thereof. In specific embodiments, one object is a pergola construct and the other is a pergola cover.

In specific embodiments, the present invention provides a fastener 100 as defined in any of the above embodiments, for joining two or more objects together, wherein the fastener 100 can be re-opened, the fastener 100 comprises: (a) a main body 102 comprising a serrated shank (shaft) with a proximal handle 103 and a deformable distal tip 101; and (b) a sleeve 110 designed to be pushed along said serrated shank from its handle 103 towards its tip 101, wherein: (i) said tip 101 is designed to be cramped when inserted through a pre-drilled hole and return to its original shape once it exits the hole on its other side, such that once the tip 101 exits the hole, it returns to its original shape and cannot be pulled back through the drilled hole, and (ii) said sleeve 110 comprises a counter shank 111 designed to interact with the serrated shank on the main body 102 to thereby prevent pulling said sleeve 110 backwards along said main body 102, wherein: the serrations/protrusions/ratchet teeth on the main body 102 as well as the inner counter protrusion(s)/ratchet tooth(s) 111 within the sleeve 110, are each constructed to partially surround said main body or the inner surface of the sleeve, respectively, i.e. being two, three, four, five, or more arches separated with a non-serrated surface, wherein the non-serrated surfaces are aligned, and are of the same or similar size of the serrates/protrusions. In this constellation, when the serrations on the main body 102 are in line with the inner counter protrusion(s) 111, the sleeve 110 cannot be pulled back/retracted. However, turning/twisting the sleeve 110 so that the inner counter protrusion(s) 111 are in line with the non-serrated surfaces on the main body 102, enables to pull the sleeve 110 back and re-open the fastener.

Unless otherwise indicated, all numbers used in this specification are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by reference to the accompanying drawings which are to be considered only as representative examples of possible embodiments of packages of the invention.

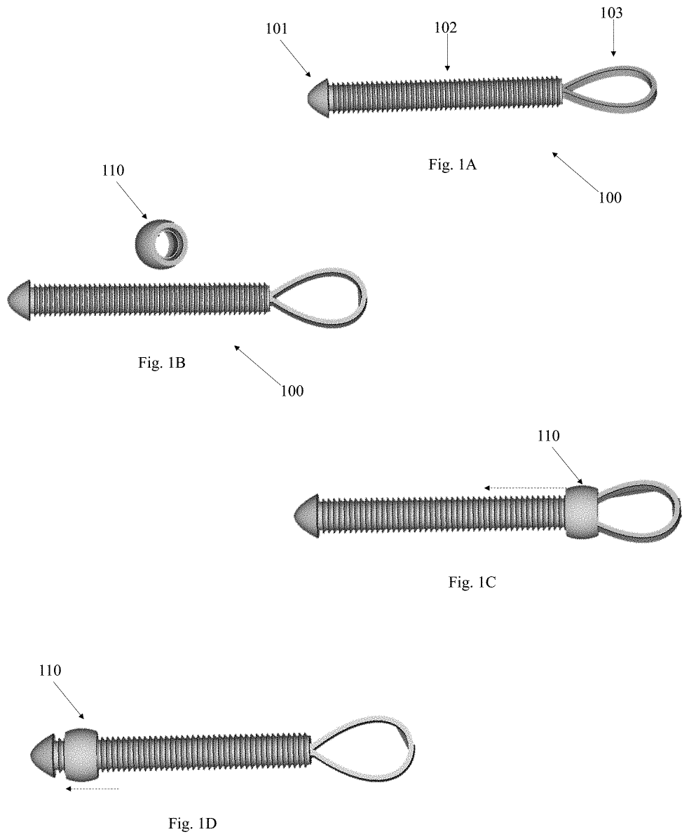

FIGS. 1A-1D illustrate a fastener 100 according to some embodiments of the invention: FIG. 1A shows the fastener's main body 102 with its serrated shank (shaft), proximal handle 103 and deformable distal tip 101. FIG. 1B illustrates that the sleeve 110 can be provided alongside the main body 102 and not mounted thereon. Alternatively, the fastener 100 can be provided/manufactured with the sleeve 110 mounted onto the main body 102 (as illustrated in FIG. 1C).

FIGS. 1C and 1D illustrate the unidirectional movement of the sleeve 110 along the main body 102 from the proximal end (where the handle 103 is) towards the distal end (where the tip 101 is). The interaction between the serrated shank on the main body 102 and the counter shank 111 within the sleeve 110 prevents the option of moving the sleeve 110 backwards—either intentionally or unintentionally.

FIGS. 2A-2C are enlargement illustrations of the fastener's components: FIG. 2A illustrates an enlargement of a section of the main body 102 and shows one possible embodiment of a serrated shank (shaft) thereon; FIG. 2B illustrates one possible configuration of the tip 101; and FIG. 2C illustrates the sleeve 110 and shows its inner counter shank 111.

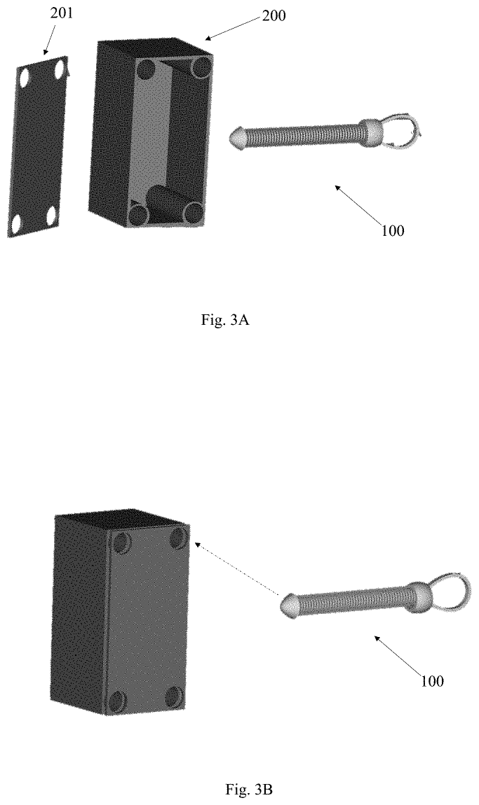

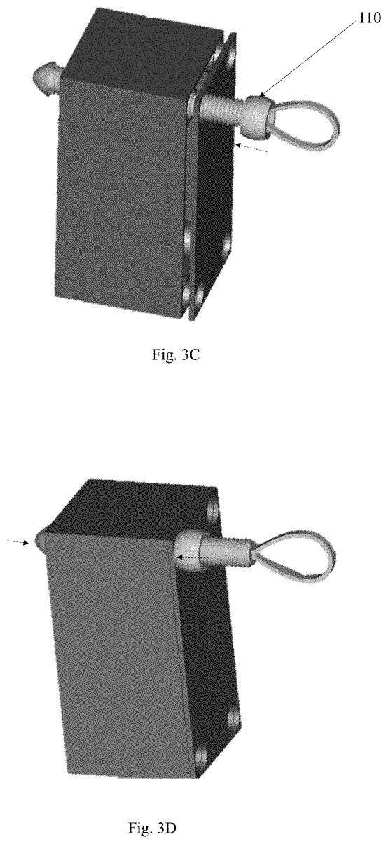

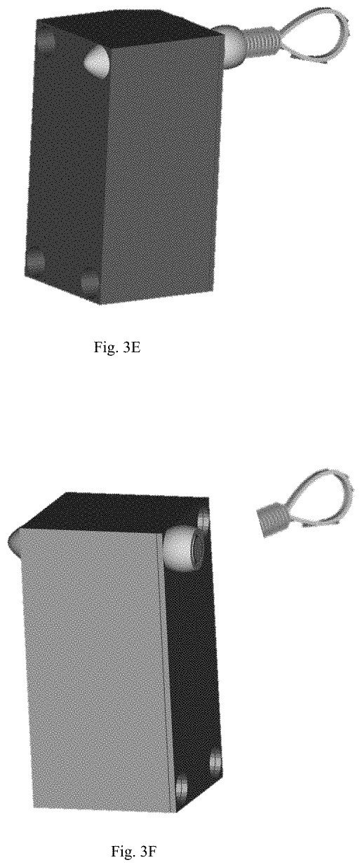

FIGS. 3A-3F illustrate how a fastener 100 according to the invention is used to connect two pieces of material 200,201 together. As illustrated, the two pieces are of different widths: FIG. 3A shows the two pieces separated; FIG. 3B shows how the holes of the two pieces are aligned to enables insertion of the fastener 100; FIG. 3C illustrates the two pieces with the fastener 100 inserted through their holes, wherein the fastener 100 and pieces are not yet fastened/secured together; FIG. 3D illustrates the unidirectional movement of the sleeve 110 towards the fastener's tip 101, while the tip 101 is pulled backwards against the external surface of the second piece 200 (see arrows); FIG. 3E illustrates the two pieces fastened together from a different point of view (from the fastener's tip direction); and FIG. 3F illustrates the final (optional) step of removing any surplus of the fastener's main body, leaving behind only an edge of the main body with the sleeve 110 mounted thereon. The removal can be done by any suitable means.

Notably, although the figures illustrate the insertion of the fastener 100 from a specific side, the same procedure can be carried out from the other direction, i.e. that the second piece 200 becomes the first piece 201, and the first piece 201 becomes the second piece 200.

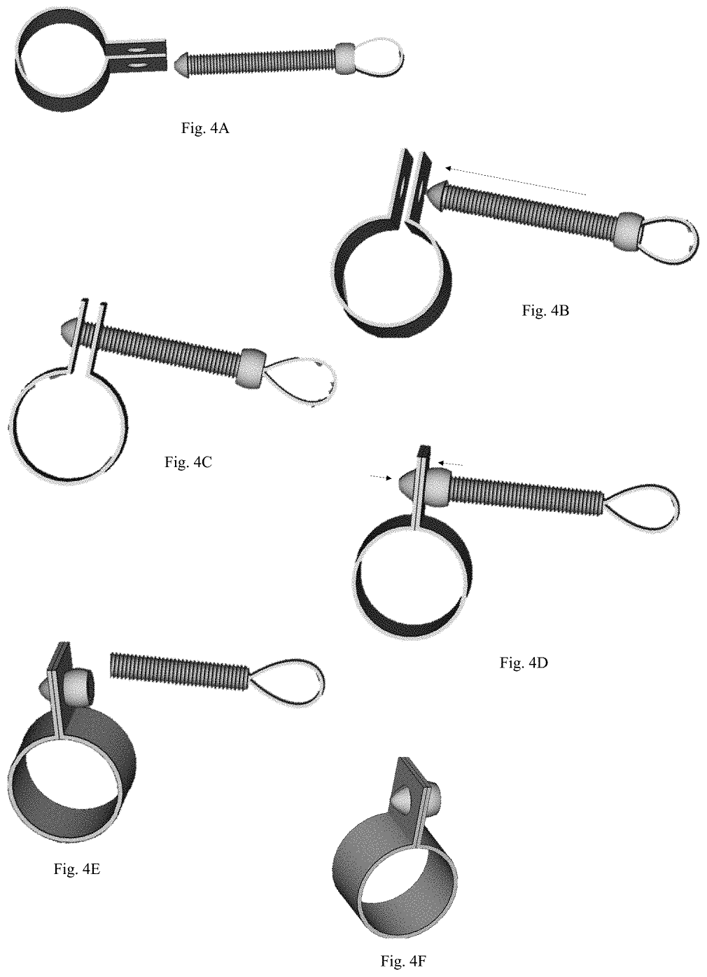

FIGS. 4A-4F illustrate how a fastener 100 according to the invention is used to connect two edges of a band together (e.g. a metal band that used for securing two pieces of pipes together, or a pipe to a wall), which is usually done with a screw and bolt (e.g. in case the user losses the bolt). As illustrated, the two edges of the band are identical: FIG. 4A shows the open band; FIG. 4B shows how the holes of the two band edges are aligned to enables insertion of the fastener 100; FIG. 4C illustrates the fastener 100 inserted through the band's holes, wherein the fastener 100 and band edges are not yet fastened/secured together; FIG. 4D illustrates the unidirectional movement of the sleeve 110 towards the fastener's tip 101, while the tip 101 is pulled backwards against the external surface of one of the band's edges (see arrows); FIG. 4E illustrates the final (optional) step of removing any surplus of the fastener's main body, leaving behind only an edge of the main body with the sleeve 110 mounted thereon. The removal can be done by any suitable means; and FIG. 4F illustrates the band of FIG. 4E from a different point of view.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless, changes and modifications, which do not depart from the teachings of the present invention, will be evident to those skilled in the art. Such changes and modifications are deemed to come within the purview of the present invention and the appended claims.

1. A fastener 100 for joining two or more objects together, comprising:
a) a main body 102 comprising a serrated shank (shaft) with a proximal handle 103 and a deformable distal tip 101; and
b) a sleeve 110 designed to be pushed along said serrated shank from its handle 103 towards its tip 101,
wherein:
said tip 101 is designed to be cramped when inserted through a pre-drilled hole and return to its original shape once it exits the hole on its other side, such that once the tip 101 exits the hole, it returns to its original shape and cannot be pulled back through the drilled hole, and
said sleeve 110 comprises an inner counter shank 111 designed to interact with the serrated shank on the main body 102 to thereby prevent pulling said sleeve 110 backwards along said main body 102.

2. The fastener 100 of claim 1, wherein said proximal handle 103 is missing.

3. The fastener 100 of claim 1, wherein said proximal handle 103 is a deformable handle that can be cramped to allow passage of the sleeve 110 thereover.

4. The fastener 100 of claim 1, wherein said main body 102 is cylinder shaped.

5. The fastener 100 of claim 1, wherein said deformable distal tip 101 is dome shaped having a diameter larger than that of the main body 102.

6. The fastener 100 of claim 1, which is provided with said sleeve 110 mounted onto said main body 102.

7. A fastener 100 for joining two or more objects together, comprising:
a) a cylinder-shaped main body 102 comprising a serrated shank with a deformable proximal handle 103 and a deformable distal tip 101; and
b) a sleeve 110 designed to be pushed along said serrated shank from its handle 103 towards its tip 101,
wherein:
said tip 101 is designed to be cramped when inserted through a pre-drilled hole and return to its original shape once it exits the hole on its other side, such that once the tip 101 exits the hole, it returns to its original shape and cannot be pulled back through the drilled hole,
said sleeve 110 comprises an inner counter shank 111 designed to interact with the serrated shank on the main body 102 to thereby prevent pulling said sleeve 110 backwards along said main body 102, and
said proximal handle 103 can be cramped to allow passage of the sleeve 110 thereover.

8. A fastener 100 for joining two or more objects together, comprising:
a) a cylinder-shaped main body 102 comprising a serrated shank with a deformable distal tip 101; and
b) a sleeve 110 designed to be pushed along said serrated shank from its proximal end towards its tip 101 at its distal end,
wherein:
said tip 101 is designed to be cramped when inserted through a pre-drilled hole and return to its original shape once it exits the hole on its other side, such that once the tip 101 exits the hole, it returns to its original shape and cannot be pulled back through the drilled hole, and
said sleeve 110 comprises an inner counter shank 111 designed to interact with the serrated shank on the main body 102 to thereby prevent pulling said sleeve 110 backwards along said main body 102.

9. The fastener 100 of claim 1, wherein said two or more objects are of the same size, width and/or material.

10. The fastener 100 of claim 1, wherein said two or more objects are of different size, width and/or material.

11. A method for joining two or more objects together without having access to one of the sides of said objects, comprising the steps of:
a) passing a fastener 100 according to claim 1 through a hole within each of said two or more objects until the fastener's tip 101 passes through all the objects and exits the hole; and
b) pushing the sleeve 110 along the main body 102 towards the tip 101,
thereby fastening said two or more objects together.

12. The method of claim 11, further comprising preliminary steps of:
drilling a hole through said two or more objects; and
optionally, aligning the holes of said two or more objects.

13. A method for joining two or more objects together without having access to one of the sides of said objects, comprising the steps of:
a) drilling a hole through said two or more objects;
b) passing a fastener 100 according to claim 1 through said hole within all the objects until the fastener's tip 101 passes through all the objects and exits the hole; and
c) pushing the sleeve 110 along the main body 102 towards the tip 101,
thereby fastening said two or more objects together.

14. The method of claim 11, further comprising a step of removing/cutting a redundant/excess part of the main body that protrudes outwardly after fastening the sleeve 110.

15. The method of claim 11, wherein one of said two or more objects is a pergola construct and the other is a pergola cover.
